(19) United States
(12) Patent Application Publication
(10) Pub. No.: US 2016/0258413 A1
(43) Pub. Date: Sep. 8, 2016

(54) HYDRAULIC APPARATUS

(71) Applicants: Mirco CASTAGNARO, Capriate San Gervasio (BG) (IT); Sara GAMBIRASI, Capriate San Gervasio (BG) (IT)

(72) Inventor: Antonino Maria LONGO, Senna Lodigiana (LO) (IT)

(21) Appl. No.: 15/028,562

(22) PCT Filed: Sep. 10, 2014
(86) PCT No.: PCT/IT2014/000242

§ 371 Date: Apr. 11, 2016

(30) Foreign Application Priority Data
Oct. 23, 2013 (IT) MI12013A001766

(51) Int. Cl. F03B 17/06

(52) U.S. Cl. CPC F03B 17/063; F05B 2240/915; F05B 2240/12

(57) ABSTRACT

A hydraulic apparatus capable of controlling water flow and converting hydraulic energy into mechanical energy and/or electricity is disclosed.

This project relates in general to the field of hydraulic systems realized on surface of water courses, it's an integrated hydraulic machine suitable to control the waters for the mechanical or electrical energy.

The hydraulic regimentation consists in the study, analysis and control of the water.

The hydraulic systems, realized on the surface of water courses, are known since latest age and generally requires civil construction, such as reservoirs and canals, for the regulation and canalization of water flow hydraulic devices comprising gates configured to intercept the flow of water and adjust the flow rate, thus allowing control the waters

Since ancient days are known hydraulic apparatuses including hydraulic wheels suitable for converting the potential energy and kinetic energy of water courses into mechanical energy in the form of rotary movement into electrical energy using appropriate generators.

Despite the wide availability of technical solutions in the field of hydraulic systems, there is still the need to provide hydraulic devices that allow to improve the mode of control the waters and their use for the production of energy, such idea constitutes one object of the present invention.

Said object is achieved with a hydraulic apparatus whose main features are specified in the first claim, while other features are specified in the remaining claims.

An idea of solution at the basic of the present invention is to realize a hydraulic apparatus provided with a movable gate and a distributor element disposed beneath it and provided with a shaped surface such as to generate an effect of deviation of the water flow intercepted by the gate.

The hydraulic apparatus further comprises a hydraulic wheel disposed downstream of the distributor element relative to the direction of water flow. The flow of water diverted from the element distributor enters the ranks of the blades of the water wheel spinning her around. The apparatus according to the invention also comprises moving means configured to selectively allow movement of the gate vertically and in an oblique direction as well as rotation with respect to the direction of flow of the water, both of the distributor element and/or the water wheel in a direction substantially vertical.

Thanks to this configuration, the apparatus is able to allow both control the waters that the conversion of hydraulic energy into mechanical energy and/or electricity.

An advantage offered by the invention is that the gate, the distributor element and the waterwheel can be jointly moved above the free surface of the water, allowing to place the apparatus in a non-operating condition in which they are temporarily restored conditions of the natural flow of the watercourse without requiring the construction of appropriate, channels for bypass.

Further advantages and characteristics of the apparatus according to the present hydraulic invention will become apparent to those skilled in the branch from the following detailed description and non-limiting the realization in various forms thereof with reference to the attached drawings in which:

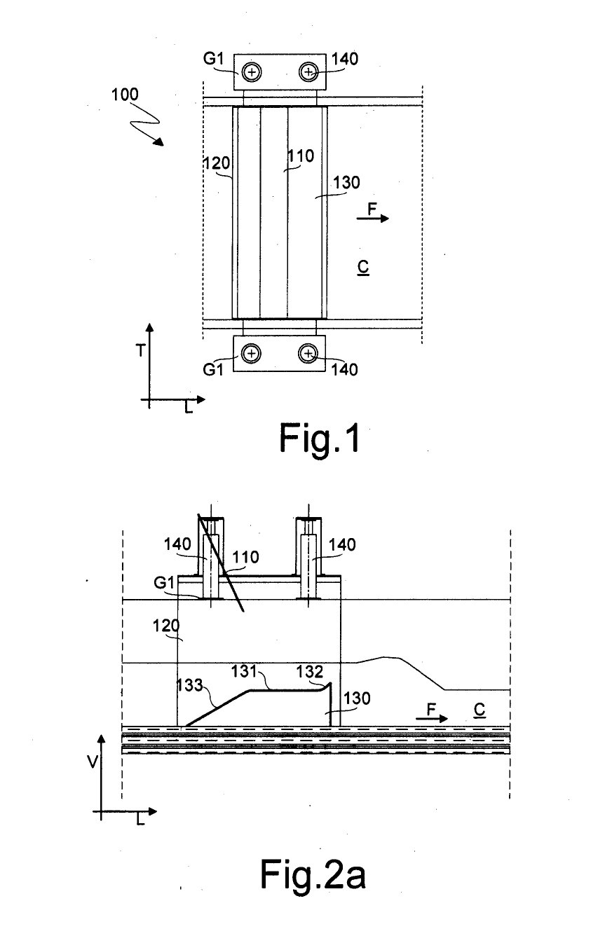

FIG. 1 is a plan view schematically showing a portion of a hydraulic apparatus according to the invention dedicated to control the waters of a surface watercourse;

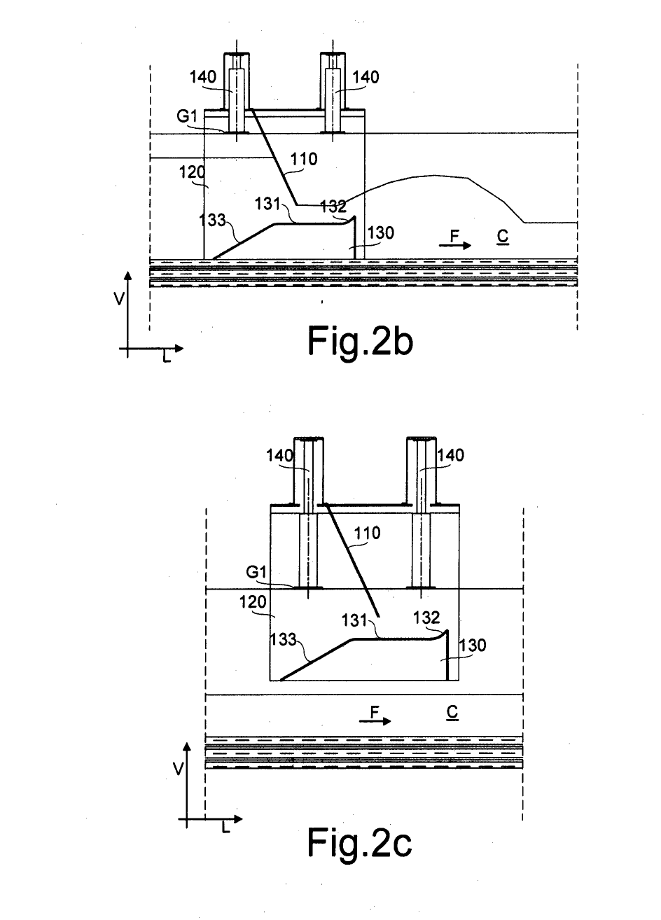

FIGS. 2a to 2c are side views that schematically show the operation of the portion of regimentation hydraulic apparatus according to the invention;

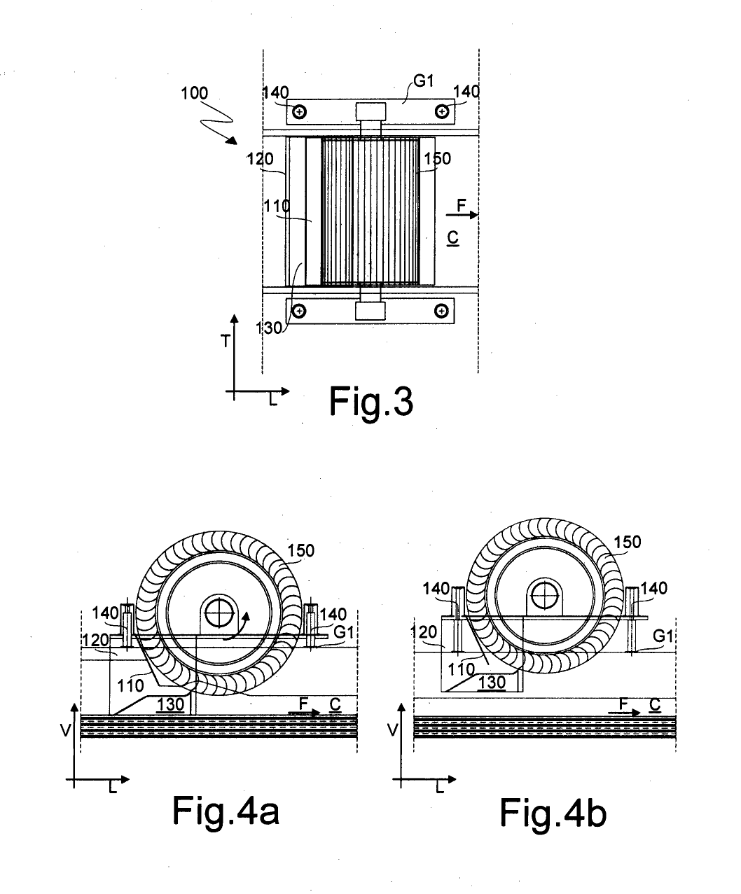

FIG. 3 is a top plan view schematically showing an embodiment of the apparatus according to the invention comprising the hydraulic portion of regimentation of water shown in FIG. 1 and a portion of converting hydraulic energy into mechanical energy and/or electricity;

FIGS. 4a and 4b are side views that schematically show some conditions of operation of the hydraulic system of FIG. 3;

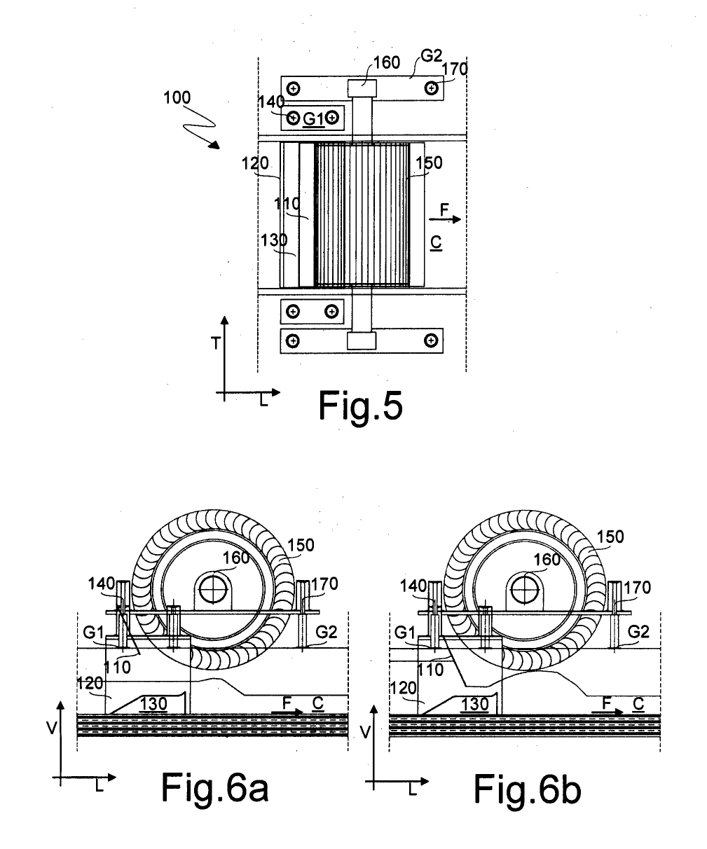

FIG. 5 is a top view schematically showing an alternative embodiment of the apparatus of FIG. 3 hydraulic; and

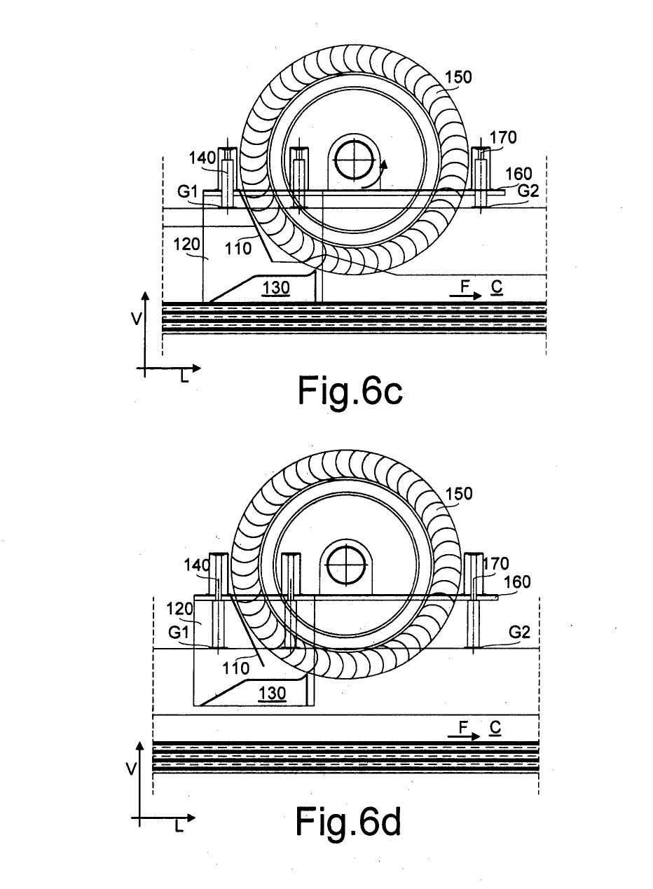

FIGS. 6a to 6d are side views that schematically show some conditions of operation of the hydraulic system of FIG. 5.

Referring to the figures, a hydraulic apparatus according to the invention is generally indicated by the reference number 100.

Referring now to FIG. 1, the apparatus (100) comprises at least one gate (110) is intended to intercept a stream of water supplied from a water course C to adjust the flow rate. In the figures, the direction of water flow is schematically indicated by an arrow (F).

The apparatus (100) further comprises a frame (120) and first moving means (not shown), such as hydraulic or mechanical actuators, connected to the frame (120) and the gate (110) to allow movement in a predominantly vertical direction (V) and substantially perpendicular to the bottom of watercourse. The frame (120) of the apparatus (100) is configured for mounting in correspondence of the watercourse (C), for example on a special metal structure (G1) support made along the canal banks and resting on relative foundations (not shown).

According to the invention, the hydraulic apparatus (100) comprises at least one distributor element (130) fixed to frame (120), for example fixed by means of bolts, and disposed under the gate (110) in the vertical direction (V). The distributor element (130) extends in a direction longitudinal axis (L) of the apparatus (100), perpendicular to the vertical direction (V), and is provided with a shaped surface comprising in succession a flat portion (131) and an inclined portion (132) oriented in an upward direction in the vertical direction (V). The distributor element (130) also extends in a transverse direction (T), perpendicular to the vertical longitudinal axis (L) and (V), for a distance substantially equal to the size of the gate (110) in the same direction, so that all the water flow intercepted by the gate (110) also affects the distributor element (130), and in particular its shaped surface.

The configuration of the hydraulic apparatus (100) is such that the inclined portion (132) of the distributor element that receives the water flow deflects upwards allowing oxygenation, what is particularly useful for the purpose of improving the chemical and physical qualities water flowing.

The set of the gate of the distributor element and therefore constitutes a portion of regimentation hydraulic apparatus (100) according to the invention.

Furthermore, the configuration of the apparatus (100) is such that hydraulic free end of the gate (110) is facing the distributor element (130) and in particular toward the plane portion (131) of its shaped surface. Therefore, with reference to the direction of flow (F), when the gate (110) is disposed underhead it determines a rise in the level of the watercourse immediately upstream and immediately downstream from a higher speed of the water as well as a contraction of the vein hydraulic, with an increase in the share of lifting of the water flow favoring further oxygenation.

According to the present invention, furthermore, the apparatus (100) comprises second moving means, for example hydraulic actuators schematically indicated with the reference number (140), mounted in the metal structure (G1) support bound to the banks of the water course (C) and connected to the frame (120). Similarly to the first moving means, even the second handling means (140) are configured to allow movement of the frame (120), and therefore also of the distributor element (130), in the vertical direction (V).

Overall, the configuration of the apparatus (100) is such as to enable to selectively actuate or move the gate (110) and the frame (120) with the distributor element (130) in the vertical direction (V).

With reference to FIGS. 2a to 2c, different operating conditions are possible.

FIG. 2a shows in particular a condition in which the frame (120) is immersed in the water course (C) and the distributor element (130) is located suction head on the bottom of the same, by diverting the flow of water upwards with reference to the vertical direction (V) in correspondence of the inclined portion (132) of the shaped surface. The gate (110) is located above the free surface of water, for which the effect of lifting of the water flow depends only on the flow of the water and (C) from the slope of the inclined portion (132) of the distributor (130).

FIG. 2b shows an operating condition similar to that of FIG. 2a, in which, however, the gate (110) is partially flooded suction, with apparatus in operation, causing a rise in water level upstream of it with respect to the flow direction (F) and therefore a greater velocity of the water in correspondence of the inclined portion (132) of the distributor element (130), which generates a greater effect of deviation, for example lifting of the flow, compared to the operating condition shown in FIG. 2a.

FIG. 2c shows instead a non-operating condition of the hydraulic apparatus (100), in which the frame (120), and consequently the distributor element (130) and the gate (110), are completely lifted above the free water surface. In this condition there is no interaction between the hydraulic apparatus (100) and the stream (C), which presents a flow condition of the all-natural.

As shown in FIGS. 2a to 2c, the contoured surface of the distributor element (130) may also comprise a further inclined portion (133) oriented in an upward direction in the vertical direction (V) and positioned upstream of the plane portion (131) in the longitudinal direction (L). The prediction of this further inclined portion (133) is advantageous since it allows to progressively drive the flow from the bottom of the watercourse (C) toward the plane portion (131) and then towards the inclined portion (132) of the distributor (130) by optimizing the flow of water and regularizing the flow water downstream of the gate (110).

The forecast of the further inclined portion (133) is particularly useful in waterways that have a substantially constant depth or waterways with varices which is installed downstream of the hydraulic system (100), while it is not strictly necessary when the ‘apparatus (100) is installed in correspondence of hydraulic jumps natural or artificial, since the plane portion (131) of the shaped surface of the distributor element (130) may be suitably arranged at different heights with respect to the jump or aligned with it according to the need.

With reference to FIG. 3, the apparatus (100) according to the invention is also provided with a portion of the conversion of hydraulic energy into mechanical energy and/or subsequently into electrical energy comprising at least one hydraulic wheel (150) disposed downstream of the distributor element (130) in the longitudinal direction (L).

In addition, similar to the distributor element (130), hydraulic wheel (150) extends in the transverse direction (T) for a distance substantially equal to the size of the gate (110) in the same direction, so that all the water flow intercepted by the gate (110) and the element distributor (130) invests the waterwheel (150) exploiting all the operational section.

The water flow distributor raised by the element (130) with the help of the gate (110) comes in the ranks of the blades of the water wheel by rotating it (150). The hydraulic apparatus (100) according to the invention thus enables both the regulation of the water course (C) that the conversion of hydraulic energy into mechanical energy, and possibly by coupling of an appropriate electric generator to the waterwheel (150).

The water wheel (150) is in particular disposed in the vicinity of the inclined portion (132) of its surface shaped so as to fully exploit the effect of lifting of the water flow.

The final slope of the inclined portion (132) may advantageously be formulated and coordinated to the shape of the blades of the waterwheel (150) for optimum operation.

According to one embodiment of the invention (not shown), the inclined portion (132) may also be constrained in a mobile way to the distributor element (130), for example pivoted in correspondence of the plane portion (131), to allow for variations in its incidence.

This configuration is advantageous because it allows for example to use the same type of distributor element with more types of hydraulic wheel simply by adjusting the incidence as a function of the geometry of the blades.

This configuration also allows to vary, in particular to optimize the operation of the hydraulic wheel in function of the conditions of the flow of the watercourse (C).

Furthermore, the gate (110) may also be constrained rotatably to the frame (120), for example pivoted, to allow a change of its slope with respect to the direction (F) of the flow of water. This configuration is advantageous because it allows for example to use the same type of gate with multiple types of hydraulic wheel simply by adjusting the incidence as a function of the geometry of the blades.

The settings of the impact of gate (110) and that of the inclined section (132) of the contoured surface of the distributor (130) are synergistic characteristics of the invention, because they allow to optimize the conditions of water flow.

This configuration allows in particular to optimize the operation of the hydraulic wheel is a function of the conditions of the flow of the watercourse (C) both reducing the turbulence in correspondence of the light between the suction head end of the gate (110) and the distributor element (130).

Referring now to FIGS. 3, 4a and 4b, according to an embodiment of the invention the water wheel (150) is mounted on the same metal structure (G1) which supports the gate (110), the frame (120) and the distributor element (130).

As shown in FIG. 4a, the hydraulic apparatus (100) can be selectively operated as described above, with the gate (110) which is located above the free water surface (condition not shown), for which the effect of lifting the water flow depends on the flow of the watercourse, and (C) from the slope of the inclined portion (132) of the distributor element (130), or (condition shown) with the gate (110) partially flooded suction, in which case it is possible to adjust the flow rate by varying the relative distance between the gate (110) and the distributor element (130).

It is also possible to a non-operating condition in which the frame (120), and thus also the gate (110), the distributor element (130) and the waterwheel (150), are completely lifted above the water surface, so the water course (C) is characterized by a condition of natural flow. This condition is shown in FIG. 4b.

According to an alternative embodiment of the invention, shown in FIGS. 5 and 6a to 6d, the water wheel (150) may be advantageously mounted on a frame (160) of the apparatus (100) totally independent of the frame (120) on which are mounted the gate (110) and the ‘distributor element (130). the frame (160) is supported by a metal structure (G2), connected to a foundation (not shown) formed along the bank of the stream (C), which are mounted on the third moving means (170), for example, always in form of hydraulic actuators, such as to enable the movement of the water wheel (150) in the vertical direction (V).

FIGS. 6a and 6b show an operating condition in which the apparatus (100) performs only a function of controlling the waters exploiting only the distributor element (130) arranged on the bottom of the watercourse (C) (FIG. 6a) or the combination of the distributor element (130) and the gate (110) (FIG. 6b). In both cases, hydraulic wheel (150) is maintained above the free surface of the water and does not interact with the water course (C).

FIG. 6c shows an operating condition in which besides the regimentation of water flow the hydraulic energy is also converted to mechanical energy and/or electricity. As can be seen, the hydraulic wheel (150) is disposed in the vicinity of the flow of water raised by the inclined portion (132) of the shaped surface of the distributor element (130) so that its blades are subjected to such a flow, and then moved by turning the wheel (150) around its own axis.

FIG. 6d shows finally a non-operating condition of the apparatus (100), in which the gate (110), the distributor element (130) and the waterwheel (150) are all raised above the water surface, for which the course of water flowing (C) normally.

It will be understood that this variant embodiment of the hydraulic apparatus (100) is particularly advantageous since it allows to manage in a selective manner and independently also the operation of the hydraulic wheel, giving operators the possibility of using the apparatus (100) for both the only control the waters of the water course (C), that for the transformation of the hydraulic energy into mechanical energy, and eventually also electric.

It will be understood also that the water wheel (150) may also be bound to a frame configured for mounting in a fixed way on the banks of the water course (C) by means of a metal support structure. However, the two embodiments described above are preferred and advantageous in that they offer both the possibility to temporarily restore the conditions of the natural flow of the watercourse without requiring the construction of channels to bypass or bypass. The command of actuators that enable to handle in the vertical direction (V), the gate (110), the frame (120) and the wheel (150), when mounted on an independent frame, can be manual or, preferably, automatically operated by a suitable control system. The present invention has hereto been described with reference to preferred embodiments. It is to be understood that there may be other embodiments afferent to the same inventive area, as defined by the scope of protection of the claims reported below.

1. Apparatus hydraulic comprising:
At least one a gate designed to intercept a stream of water supplied by a water course to adjust the flow rate,
a frame configured for mounting on the banks of said water course by a metal structure of the apparatus,
a first moving means mounted between said frame and said gate to allow movement of the gate in a direction of the apparatus predominantly vertical,
a distributor element fixed to the frame and disposed below the gate in said vertical direction, said distributor element extending in a longitudinal direction of the apparatus, perpendicular to the vertical direction, and being provided with a shaped surface comprising in succession a flat portion and an inclined portion oriented in an upward direction in the vertical direction, a second moving means mounted in the metal structure and connected to the frame to allow displacement of the latter frame and of the distributor element in the vertical direction,
a hydraulic wheel disposed downstream of the distributor element in the longitudinal direction.

2. Apparatus according to claim 1, wherein the water wheel is mounted on the same frame to which are bounded the gate and the distributor element.

3. Apparatus according to claim 1, further comprising a frame independent from the frame on which are bounded the gate and the distributor element, said frame being suitable for support the hydraulic wheel and configured to be mounted on the banks of said water course by a further metal structure of the apparatus, and wherein the apparatus further comprises third moving means connected between the frame which supports the water wheel and said further metal structure to allow displacement of the hydraulic wheel in the vertical direction.

4. Apparatus according to claim 1, wherein the water wheel is mounted on a frame configured for mounting on the banks of said water course by a metal support structure, said frame being fixed with respect to said metal support structure.

5. Apparatus according to claim 1, to wherein the distributor element and the hydraulic wheel also extend in a transverse direction, perpendicular to the vertical direction and longitudinal, for a distance substantially equal to the dimension of the gate in the same direction.

6. Apparatus according to claim 1, wherein the water wheel is disposed in the vicinity of the inclined portion of the shaped surface of the distributor element.

7. Apparatus according to claim 1, wherein a free end of the gate is directed toward the flat portion of the shaped surface of the distributor element.

8. Apparatus according to claim 1, wherein the gate is connected rotatably to the frame and wherein the inclined portion of the shaped surface of the distributor element is attached rotatably to the flat portion of the same surface shaped to allow for variations of their inclination relative to the direction of the flow of water flowing in the water course.

9. Apparatus according to claim 1, wherein the contoured surface of the distributor element further comprises a further inclined portion orientated in the upward direction in the vertical direction and arranged upstream of the plane portion in the longitudinal direction.

10. Apparatus according to claim 1, further comprising a control system configured for driving the moving means.
